(19) United States
(12) Patent Application Publication
(10) Pub. No.: US 2025/0123844 A1
(43) Pub. Date: Apr. 17, 2025

(54) METHOD AND APPARATUS FOR SOFTWARE-DIRECTED INHIBITING OF BRANCH PREDICTION IN COMPUTING DEVICES

(71) Applicant: HUAWEI TECHNOLOGIES CO., LTD., SHENZHEN (CN)

(72) Inventors: Maziar GOUDARZI, Kanata (CA); Reza AZIMI, Kanata (CA); Viatcheslav STEPANOV, Kanata (CA)

(73) Assignee: HUAWEI TECHNOLOGIES CO., LTD., SHENZHEN (CN)

(21) Appl. No.: 18/380,409

(22) Filed: Oct. 16, 2023

(51) Int. Cl. G06F 9/38

(52) U.S. Cl. CPC G06F 9/3806

(57) ABSTRACT

Methods and apparatus for inhibiting branch prediction unit operations of a computer are provided. Program code is generated having instructions which inhibit branch prediction prior to a stable path being executed, the stable path being stable (e.g. with all instructions executed sequentially as they occur in memory) with high likelihood. The instructions when executed trigger such branch prediction unit inhibition. The instructions can be generated so as to have a high prevalence, length, or both, of stable paths.

### CROSS-REFERENCE TO RELATED APPLICATIONS

This is the first application filed for the present invention.

### FIELD OF THE INVENTION

The present invention pertains to computing devices executing computer code, and in particular to methods, systems and apparatus for managing the branch prediction components in such computing devices.

### BACKGROUND

Branch prediction is an operation in computer processors by which an attempt is made to predict the next instructions to be executed when running a program, so that proactive execution of such instructions can begin. Specialized hardware for such tasks, such as the branch-prediction (BP) complex, can be among the heaviest power-consumers in a high performance computer processor core. Conventionally, BP is actively used for every instruction-fetch operation, to predict branches in the fetched instructions, and accordingly predict the directions and targets of those branches. Such action is used to healthily feed instructions into the processor pipeline for high performance.

Reducing power consumption of the BP complex is difficult, since, conventionally, BP is actively consulted for every instruction-fetch. Upon an instruction-fetch, the instruction is not yet decoded, and hence, BP is consulted to identify (i) if one of the fetched instructions is a branch instruction, and (ii) if so, whether that branch is being taken or not, and (iii) if taken, what is the target address to branch to.

U.S. Pat. No. 10,289,417 describes a process of predicting blocks of instructions that are branch-free, following a predicted branch. If such case is identified, (parts of) branch-prediction is suppressed for the subsequent one or two blocks of instructions. Prediction of such branch-free blocks is done based on prior history of execution. However, this approach requires additional hardware to monitor instruction blocks and identify branch-free ones. This leads to the need for additional circuitry as well as extra power consumption. Additionally, the approach relies on short-term repeat of the branch-free regions (otherwise the history information is overwritten by the information of other regions, and thus gets lost), and thus fails to detect the branch-free regions if the repeat-cycle is long (e.g. if there are many other branches in between two subsequent instances of the branch-of-interest). Additionally, the approach is restricted to small number of small branch-free blocks to control the overhead; the overhead here is the additional bits in the branch target buffer (BTB) for potential branch-free subsequent blocks, and also each block is a fetch-bundle which is typically only a few instructions. Furthermore, the approach is restricted to branch-free regions of code. This approach thus fails to address opportunities in which highly biased branches (i.e. branches with very low probability of being taken) might be present.

Therefore, there is a need for methods, systems and apparatus for inhibiting branch prediction, that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

The disclosure may provide for methods, systems and apparatus related to temporarily inhibiting (e.g. disabling or operating at a reduced power level or capacity) the branch prediction unit in computing devices. The branch prediction unit is inhibited when not required, e.g. when executing certain portions (blocks) of executable computer program code in which the program counter increments sequentially. This can result in power savings or other efficiencies. When the code is created, for example by a compiler, instructions are included in the code for inhibiting branch prediction, on the premise that the code portion to be executed after such inhibition is likely executable by sequentially incrementing the program counter. When the code is executed by a computer, the instructions are followed and branch prediction is inhibited. Thus, the inhibition is directed by software. In this way, the executing computer does not expend significant extra effort to identify opportunities for inhibiting branch prediction, but rather this effort is made primarily by the code-creating compiler). Furthermore, because the effort is made by the code-creating compiler, this compiler (a computer) can increase the occurrence or benefit of branch prediction inhibition opportunities, by creating the code in such a way that such portions for which branch prediction can be inhibited are longer, more prevalent, or both.

According to an aspect, there is provided a computer apparatus comprising a processor operatively coupled to memory. The apparatus is configured to generate executable computer program code having a code portion (the stable path) which consists essentially of a plurality of instructions to be most probably executed in a sequence. The plurality of instructions occur in the stable path contiguously according to the sequence. Generating the code includes arranging the computer program code to maximize a length of the stable path while respecting one or more conditions or constraints. Generating the code comprising including an indicator therein to inhibit operation of a branch prediction unit during execution of the stable path. The apparatus is configured to store the generated executable computer program code (e.g. in internal or external memory) for subsequent use by the apparatus or another apparatus.

In some embodiments, the one or more constraints or conditions include maintaining at least a threshold probability that the plurality of instructions, e.g. as stored contiguously in memory, will be executed in sequence.

In some embodiments, the indicator is a specialized branch instruction which leads to the stable path. In some embodiments, the indicator is a marker instruction. In some embodiments, the indicator is an instruction included in the computer program code along with but separate from a branch instruction which leads to the stable path. In some embodiments, the indicator is an instruction which precedes the stable path by a fixed number of instructions and which indicates a start of the stable path.

In some embodiments, the arranging includes generating, executing and analyzing candidate versions of the executable program code, and adjusting the candidate versions of the program code to arrive at the generated executable program code based on the analyzing. The analyzing may include determining an indication of probability that the plurality of instructions will be executed in sequence.

According to another aspect, there is provided a computer apparatus comprising a processor operatively coupled to memory and a branch prediction unit. The apparatus is configured to execute computer program code stored in memory and having a code portion (the stable path) which consists essentially of a plurality of instructions to be most probably executed in a sequence. The plurality of instructions occur in the stable path contiguously according to the sequence. The apparatus is configured to read, in the computer program code, an indicator corresponding to the stable path approaching execution. The indicator is included in the computer program code during generation thereof, for example as an instruction. The apparatus is configured, in response to reading the indicator, to inhibit operation of the branch prediction unit during at least one subsequent execution of the stable path.

In some embodiments, the indicator indicates that the stable path is about to be executed or is predicted to be executed. In some embodiments, the indicator is associated with a branch instruction leading to the stable path. In some embodiments, the indicator is associated with a start of the stable path.

In some embodiments, inhibiting operation of the branch prediction unit includes storing data in a data structure which is also used for support operation of the branch prediction unit. The stored data is used in triggering the inhibiting operation of the branch prediction unit during at least one subsequent execution of the stable path.

In some embodiments, inhibiting operation of the branch prediction unit includes storing data in a data structure which is dedicated for use in triggering said inhibiting operation of the branch prediction unit during at least one subsequent execution of the stable path.

In some embodiments, the indicator is included in the computer program code as a specialized branch instruction which leads to the stable path. In some embodiments, the indicator is included in the computer program code along with but separate from a branch instruction which leads to the stable path. In some embodiments, the indicator is included in the computer program code as an instruction which precedes the stable path by a fixed number of instructions and which indicates a start of the stable path.

In some embodiments, the indicator indicates a length of the stable path and the apparatus is configured to cease inhibiting operation of the branch prediction unit following execution of the stable path. The length can be used to determine such an end of inhibition.

According to another aspect, there is provided a non-transitory computer readable medium having stored thereon computer program code. The code includes a code portion (the stable path) which consists essentially of a plurality of instructions to be most probably executed in a sequence. The plurality of instructions occur in the stable path contiguously according to the sequence. The code includes an indicator in the computer program code and corresponding to the stable path approaching execution. The indicator is included in the computer program code during generation thereof. In response to the indicator being read by a computer apparatus executing the computer program code, the apparatus inhibits operation of the branch prediction unit during at least one subsequent execution of the stable path. Further details of this aspect may be provided commensurate with aspects already set forth above.

According to another aspect, there is provided a method comprising, by a computer: generating executable computer program code having a stable path which consists essentially of a plurality of instructions to be most probably executed in a sequence. The plurality of instructions occur in the stable path contiguously according to the sequence. The generating of the executable computer program code includes arranging the computer program code to maximize a length of the stable path while respecting one or more conditions or constraints. The generating of the executable computer program code includes including an indicator therein to inhibit operation of a branch prediction unit during execution of the stable path. The method includes storing the generated executable computer program code for subsequent use. Further details of this aspect may be provided commensurate with aspects already set forth above.

According to another aspect, there is provided a method comprising, by a computer having a branch prediction unit: executing computer program code stored in memory and having a stable path which consists essentially of a plurality of instructions to be most probably executed in a sequence. The plurality of instructions occur in the stable path contiguously according to the sequence. The method includes reading, in the computer program code, an indicator corresponding to the stable path approaching execution. The indicator is included in the computer program code during generation thereof. The method includes, in response to reading the indicator, inhibiting operation of the branch prediction unit during at least one subsequent execution of the stable path. Further details of this aspect may be provided commensurate with aspects already set forth above.

According to one aspect, an apparatus may be provided, where the apparatus includes: a memory, configured to store a program; a processor, configured to execute the program stored in the memory, and when the program stored in the memory is executed, the processor is configured to perform one or more of the methods and systems described herein. The apparatus may create the code which inhibits branch prediction, or execute such code, or both for example at different times.

According to another aspect, a computer readable medium may be provided, where the computer readable medium stores program code executed by a device and the program code is used to perform one or more of the methods and systems described herein.

According to one aspect, a chip may be provided, where the chip includes a processor and a data interface, and the processor reads, by using the data interface, an instruction stored in a memory, to perform one or more of the methods and systems described herein. Aspects may further include the memory.

Other aspects of the disclosure provide for apparatus, and systems configured to implement the methods according to the first aspect disclosed herein. For example, computers can be configured with machine readable memory containing instructions, which when executed by the processors of these devices, configures the device to perform one or more of the methods and systems described herein.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 illustrates a computer apparatus executing code and inhibiting a branch prediction unit, according to embodiments of the present disclosure.

FIG. 2 illustrates components of a computer apparatus executing code and inhibiting branch prediction, according to embodiments.

FIG. 3 illustrates a timeline in which branch prediction is inhibited, according to an embodiment.

FIG. 4 illustrates a timeline in which branch prediction is inhibited, according to another embodiment.

FIG. 5 illustrates a computer apparatus generating code including instructions for inhibiting branch prediction, according to embodiments.

FIG. 6 illustrates an example of code before code layout marshalling, according to an embodiment.

FIG. 7 illustrates an example of code after code layout marshalling, according to an embodiment.

FIG. 8 illustrates an example of code laid out in address space and provided in accordance with embodiments of the present disclosure.

FIG. 9 illustrates a computer apparatus according to embodiments of the present disclosure.

It will be noted that throughout the appended drawings, like features are identified by like reference numerals.

### DETAILED DESCRIPTION

Apparatus, methods and systems related to inhibiting of a branch prediction unit of a computer processor are provided. Conventional branch prediction (BP) is performed (by a BPU) without using information regarding sequentially executed portions of computer program code (in which the entire portion can be executed by simple incrementing of the program counter). Therefore, such conventional BP operates nonstop to identify the branches in all and every instruction-fetch. This is a root cause of continuous activity, and thus power consumption, by the BP. To remedy this, according to embodiments, stable paths (described below) in the code can be generated and identified. While executing a stable path, branch prediction is not necessary because instructions are executed in sequence, at least with high likelihood. Basic blocks (BBs) of the code can be reordered during program compilation/generation to create or increase the length, prevalence, or both, of such stable paths. The computer hardware executing the code is then informed of such contiguously laid out stable paths. In response to such information, BP may be inhibited (e.g. disabled) for the duration of fetching for the stable-path. This can facilitate a saving of dynamic power that would have otherwise been dissipated for the activity in the BPU.

As used herein, the code portion consisting essentially of instructions to be most probably executed in sequence, with the instructions occurring in the code portion contiguously according to the sequence, is referred to as a “stable path” The stable path may be an execution path consisting of one or more basic blocks (BBs) such that (i) they are laid out sequentially in memory, and also (ii) most of the time (e.g. above a certain adjustable confidence level, C), the entire sequence of instructions in the stable path is executed sequentially from the beginning of the stable path up until its end; that is, the branch instructions in the stable-path are often either not-taken, or if taken, the target PC of the branch is the next sequential PC after the branch instruction. Another perspective here is that the branch instruction can be a conditional branch instruction with a high likelihood that its condition fails, and if the condition fails the branch is not taken, meaning that, instead, the next instruction sequentially in memory gets executed. Accordingly, in various embodiments, when executing the stable path, the program counter will be incremented by one (or one unit) each time a new instruction is to be performed, and the instructions will be stored in memory one after the other, contiguously and in sequence. According to embodiments, the stable paths are assumed to be contained in a single function. Accordingly, in such embodiments, none of the branches in the stable path are either “CALL” or “RETURN” instructions.

A basic block (BB) is a sequence of instructions with a single entry and a single exit. A basic block always ends with a branch instruction, but there is no other branch instruction in the BB. A branch instruction may be an instruction which alters the processor's program counter. The program counter maintains the memory address of the next instruction to be fetched and executed. Jump, call and return instructions are types of branch instructions.

The above-mentioned confidence level C may be defined as follows. A stable-path may be regarded as being stable with at least a confidence-level C, if and only if the probability of observing the exact sequence designated by the stable-path is above C (e.g. as a fraction or percentage) whenever the start-program counter of that stable-path is observed in a profiled trace of execution of the program code. Such a confidence level may be determined by profiling the application as explained elsewhere herein.

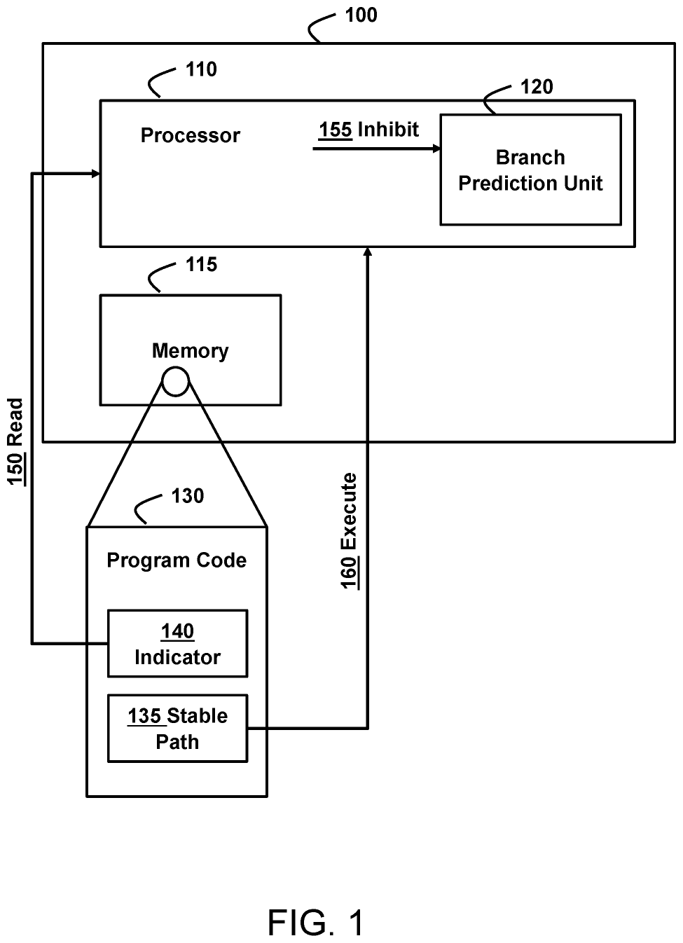

Referring to FIG. 1, embodiments of the present disclosure provide for a computer apparatus 100 having a processor 110 operatively coupled to memory 115. The apparatus (or the processor) further includes a branch prediction unit 120, along with associated hardware components. The memory 115 includes a portion (e.g. an L1 cache) which stores computer program code 130 for execution by the processor. The code 130 includes the stable path 135.

The code also includes an indicator 140 which corresponds to the stable path 135 approaching execution. For example, the indicator can be associated with a branch in the code which leads to the stable path 135. As another example, the indicator can be associated with a beginning of the stable path 135. The indicator can be a special branch instruction, or a dedicated computer program instruction which accompanies the branch instruction or which is placed in advance of the stable path 135. Notably, the indicator is included in the computer program code during prior generation of the code, e.g. by a compiler. Thus, the apparatus 100 does not need to insert or manage insertion of the indicator 140 unless it is also the apparatus which previously compiled the code. The indicator can be that the stable path is about to be executed, for example when the indicator or an associated instruction is provided to the processor for execution. The indicator can be that the stable path is predicted to be executed, for example when the indicator or an associated instruction is identified for execution by the branch prediction unit, which predictively causes instruction loads but not necessarily with 100% accuracy.

The apparatus 100 (e.g. the processor 110) is configured to read 150 the indicator 140 as part of its normal executing of the program code 130. In response to reading the indicator 140, the apparatus 100 is further configured to inhibit 155 operation of the branch prediction unit 120 (typically part of the processor) during at least one subsequent execution 160 of the stable path 135. Depending on implementation, this at least one subsequent execution can be the immediately next execution of the stable path following reading the indicator 140. Additionally or alternatively, this at least one subsequent execution can be a repeated execution of the stable path which occurs after the immediately next execution of the stable path following reading the indicator 140.

Inhibiting operation of the branch prediction unit can involve disabling the branch prediction unit for example by powering off the branch prediction unit. Inhibiting operation of the branch prediction unit can involve operating the branch prediction unit in a lower power (e.g. “drowsy”) mode in which it operates at a reduced capacity or functionality.

According to some embodiments, the mechanism for inhibiting the branch prediction unit is engaged at a point of control which is the branch (e.g. branch instruction) leading to the stable path. The indicator for inhibiting operation of the branch prediction unit can accordingly be associated with a branch instruction leading to the stable path. For example, when a branch instruction which leads to the stable path is executed or predicted to be executed, the branch prediction unit may be inhibited or preparations can be made to inhibit the branch prediction unit, e.g. at a next instance or a predicted next instance of the branch instruction.

According to some embodiments, the mechanism for inhibiting the branch prediction unit is engaged at a point of control which is the start of the stable path. The indicator for inhibiting operation of the branch prediction unit can be associated with a start of the stable path. For example, when a start of the stable path is executed, the branch prediction unit may be inhibited. In this case, an instruction for inhibiting the branch prediction unit may be read in advance of the start of the stable path, in time for preparations to be made for inhibiting the branch prediction unit e.g. when execution of the stable path begins.

According to some embodiments, the information storage for identification of the point of control (at which the mechanism for inhibiting the branch prediction unit is engaged) is part of a pre-existing predicting data structure for example which is also used for branch prediction or related operations. This is referred to as a “linked” information storage. The predicting data structure can be modified to include an additional field to store the relevant branch or path information. This information can be maintained until the predicting entry is evicted, for example. The predicting entry is an entry in the predicting data structure that corresponds to a point of control. The information in the predicting entry may be used for predicting whether the branch will be taken or not. An example of such a data structure is a Branch Target Buffer (BTB). Accordingly, inhibiting operation of the BPU can include storing data in such a pre-existing data structure. (The stored data is used in triggering inhibiting operation of the branch prediction unit during at least one subsequent execution of the stable path.) The data structure, being pre-existing, is thus also used for support operation of the branch prediction unit.

According to some embodiments, the information storage for identification of the point of control (at which the mechanism for inhibiting the branch prediction unit is engaged) is an additional data structure which exists and is dedicated for this purpose. This is referred to as a “detached” or “dedicated” information storage. The information can be maintained until it is consumed or overwritten, for example. Accordingly, data for use in inhibiting operation of the branch prediction unit during an execution of the stable path can be stored in such a dedicated data structure. Similarly, inhibiting operation of the BPU can include storing data in this dedicated data structure. (Again, the stored data, and the dedicated data structure, is dedicated for use in triggering inhibiting operation of the branch prediction unit during at least one execution of the stable path.)

According to some embodiments, the information in the computer code which initiates inhibiting of the branch prediction unit (the indicator) is associated with the branch (e.g. branch instruction) leading to the stable path. For example, the branch instruction which leads to the stable path may be a specialized branch instruction which also initiates present inhibiting of the branch prediction unit, and thus also acts as the indicator inhibiting operation of the branch prediction unit. Additionally or alternatively, the branch instruction which leads to the stable path may be a special branch instruction which also initiates inhibiting of the branch prediction unit on a subsequent execution of the branch instruction leading to the stable path (or the stable path itself). In some embodiments, the inhibition can be initiated when the branch instruction is executed or about to be executed. In some embodiments, the inhibition can be initiated when the branch instruction is predicted to be executed.

According to some embodiments, the information in the computer code which initiates inhibiting of the branch prediction unit (the indicator) is associated with a dedicated instruction referencing to the point of control, e.g. the branch leading to the stable path or the start of the stable path. For example, the branch instruction which leads to the stable path may accompanied by a special dedicated instruction which initiates present inhibiting or future inhibiting (e.g. on a subsequent execution of the branch instruction) of the branch prediction unit. As another example, the start of the stable path may be accompanied (e.g. preceded) by such a special dedicated instruction. The dedicated instruction can be an instruction to inhibit the branch prediction unit at a certain offset of the program counter or the like. Therefore, the dedicated instruction (indicator) can be an instruction which precedes the stable path by a (e.g. fixed) number of instructions and which indicates a start of the stable path. The dedicated instruction can be an instruction to write to the information storage for identification of the point of control in a particular manner which will inhibit the branch prediction unit. Again, in some embodiments, the inhibition can be initiated when the special instruction is executed or about to be executed. In some embodiments, the inhibition can be initiated when the special instruction is predicted to be executed.

In various embodiments, according to the above, the hardware executing the code relies on software information and inhibits branch prediction for the duration of instruction fetching from the stable-path. Thus, there is no need to spend energy and storage space to identify the stable paths by the hardware (executing computer). For example, the start-program counter and length of the stable-path may be given by the code-generating computer to the code-executing computer via the code itself. When instruction fetching reaches the start-PC of the stable-path, BP is inhibited (disabled); after fetching a certain indicated (length) number of instructions, BP is disinhibited or re-enabled (e.g. by the instruction fetch unit (IFU)) and continues its normal operation.

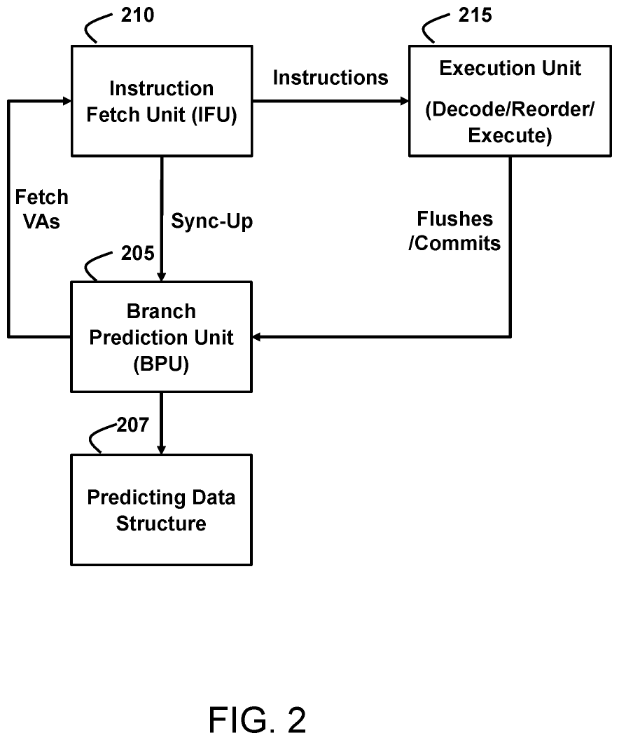

FIG. 2 illustrates a CPU core with a branch prediction unit (BPU) 205 and an instruction fetch unit (IFU) 210, according to an illustrative embodiment. The CPU core also includes an execution unit 215 which decodes, reorders and executes instructions. The IFU 210 fetches instructions from memory and provides them to the execution unit 215 for execution. The execution can be pipelined with the execution unit 215 having multiple components which pass instructions to one another, as will be readily understood by a worker skilled in the art.

The BPU 205 generates a sequence of Fetch Virtual Addresses (VAs) and sends them to the IFU 210, which fetches the correspondingly predicted instructions from the CPU memory system (typically a Level 1 Instruction Cache). The instructions are then forwarded to the execution unit 215, which may include a decode/rename/execution CPU pipeline.

Both the BPU 205 and IFU 210 may be pipelined to achieve a higher performance via a higher clock rate. The two pipelines run independently, but there is a synchronization mechanism that allows, in particular, to update the BPU state based on monitoring and partial decoding of the actual fetched instruction stream by the IFU. For example, the IFU may provide information to the BPU to influence the BPU's operation.

Furthermore, upon execution/flush and commit of a branch instruction by the execution unit 215, the BPU's state is updated based on the branch execution status.

According to some embodiments, in relation to FIG. 2, during code generation (e.g. by a compiler) branch instructions leading to stable paths are marked. This marking may be in the form of a special branch instruction code which is distinct from at least one other branch instruction code that does not have the same effect. This marking may alternatively be in the form of a special “marker” instruction which occurs (e.g. immediately) prior to the branch. In either case, the marking may indicate a length of the stable path in suitable units, such as a number of instructions or a number of some predetermined multiple (e.g. 4) of instructions.

During execution of the previously generated code, the hardware of FIG. 2 operates as follows. The IFU 210 will detect a branch instruction which is marked as noted above. Upon such detection, the IFU 210 informs the BPU 205 of this detection event via the synchronization channel between the IFU and the BPU. In some embodiments, the BPU reacts to this information from the IFU substantially immediately after being informed of the marked branch instruction by the IFU. In some embodiments, the BPU reacts to this information from the IFU after the corresponding (e.g. marked branch) instruction is committed by the execution unit 215. Since the IFU may be fetching instructions which are predicted to be executed in future, this means that the BPU can react based on marked branch instructions which are executed, or based on marked branch instructions which are predicted to be executed (and in this case fetched for execution).

To use the information provided by the IFU, the BPU 205 stores the stable path information, as indicated by the marked branch instruction, in a predicting data structure 207, such as the Branch Target Buffer (BTB). The information may be stored into a dedicated field in the entry predicting the marked branch instruction. This information may persist as long as the entry is maintained in the predicting structure.

Subsequently, the next time the same branch is predicted, the stored contents of the field are used to inhibit operation of the BPU 205 at least for the targeted stable path. With the BPU inhibited, a simple sequentially/linearly incrementing series of Fetch VAs is used instead, i.e. the instructions are fetched from memory as they occur contiguously in order.

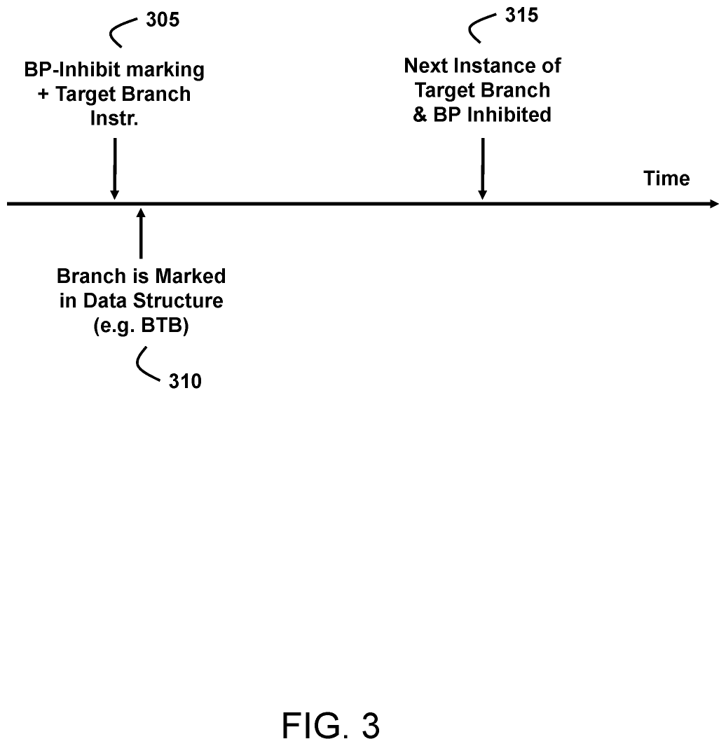

The above solution utilizes repeatability of stable paths, because it applies to the next instance of the stable path, not to the current one. This is illustrated in FIG. 3. The BPU receives the information, corresponding to the marked branch instruction, from the IFU at time 305. The BPU stores the information in a data structure such as the BTB at the same or nearby time 310. The next instance of the target branch is predicted, by the BPU, to be executed at a later time 315. The BPU operation is also inhibited at or shortly following this time 315.

According to another embodiment, a marking is provided, e.g. in the computer program code, which identifies the starting location of the stable path within the program code, for example by indicating the program counter value corresponding to this starting location. The corresponding information may be kept in a separate or detached structure, such as a data structure dedicated for use in triggering BPU inhibiting operation. Furthermore, a dedicated instruction is used to transfer the corresponding information from software to hardware. For example, the dedicated instruction can be separate from a branch instruction leading to the stable path. The dedicated instruction can be the marking in various embodiments.

The dedicated instruction can be of the form BP-disable <offset>, <len>. Such an instruction, when executed, has the effect of disabling the branch prediction unit, starting from the block of instructions at the address current PC+<offset> (where current PC is the current program counter value). The branch prediction unit is re-enabled after <len>number of instructions (or instruction-bundles, as below) are fetched after the starting instruction address. Accordingly, <offset> is an offset from the current program counter value, that leads to the target stable path. Value <len> is the length of the stable path measured in predetermined units, such as instructions or a multiple (e.g. 4) of instructions. The computer may cease inhibiting operation of the branch prediction unit (e.g. re-enable the BPU or restore the BPU to full operation) following executing of the stable path as indicated by the length value.

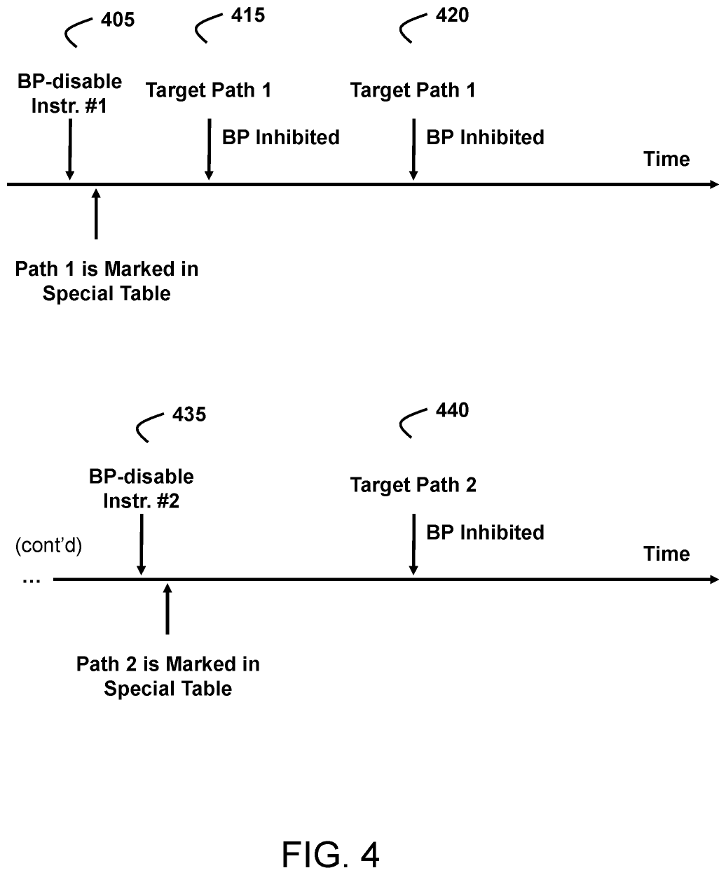

In various embodiments, if the target stable path is repeated in a loop, one single marking (e.g. one BP-disable instruction) can be placed before the loop, and this may be sufficient for disabling the branch prediction unit. An example is given with reference to FIG. 4. FIG. 4 illustrates a timeline in which a first BP-disable instruction 405 is provided, which causes the branch prediction unit to be inhibited for two iterations 415, 420 of a corresponding first target stable path. This may be because the program counter resets to the starting instruction address at the beginning of the second iteration 420. A second BP-disable instruction 435 causes the branch prediction unit to be inhibited for an iteration 440 of a second corresponding target stable path. Shortly after each BP-disable instruction is read, the corresponding stable path is marked in a dedicated data structure (special table).

In embodiments, depending on the size of the additional dedicated data structure (e.g. added to the IFU) to maintain information about stable paths, a second marking for the second target stable path may overwrite the marking for the first target stable path. In this case, a repeat of the first target stable path marking may be required if and when that target stable path is going be fetched again, for example due to an outer loop (not shown).

The above embodiments are provided as examples, and it is noted that other embodiments may be provided for, commensurate with the overall description.

Embodiments corresponding to executable computer program generation will now be described in more detail. The code is generated in such a way that at least one stable path is present. The code may be optimized to include as many instances of such stable paths as is practical, given other constraints. The code may be optimized so that such stable paths are as long as is practical, given other constraints. Thus, the size, prevalence, or both size and prevalence of stable paths may be purposefully increased or maximized. For example, generating the code can include arranging the code to maximize a length of at least one stable path, while respecting other conditions or constraints if required. Once or more such constraints can relate to the probability (likelihood or confidence level, or proportion of times) that the stable path will in fact be stable. For example, the code may be generated such that at least a predetermined threshold probability of the stable path being stable (e.g. 80%, 90%, 95% or 99%) is maintained. Furthermore, during code generation, the indicators which are subsequently used to inhibit operation of a branch prediction unit, during subsequent execution of the stable path, are included within the code such that they identify the stable path to facilitate such inhibition. The code is stored in memory as computer program code, whereupon it can be executed by the same computer that generated the code, or by a different computer once transferred thereto.

In other words, the computer program generation involves generating executable computer program code having a stable path which consists essentially of a plurality of instructions to be most probably executed in a sequence (e.g. with at least a threshold probability). The plurality of instructions, being the stable path, occur contiguously according to the sequence.

Generally speaking, the longer a stable path is, the lower the probability is that it might be stable (assuming it is not 100% guaranteed stable but only stable with some probability less than one due to branch instructions which are sometimes executed in a manner that the next instruction does not immediately follow such a branch instruction). The length of the stable path may be interpreted in this context as the number of basic-blocks, rather than the number of instructions in the stable path. Furthermore, a stable path is always call-free (i.e., it will never contain a function call/return) except potentially as the very last instruction of the stable path. As mentioned above, the generating of the executable computer program code can include arranging this computer program code in a manner which maximizes or substantially maximizes a length of the stable path while respecting one or more conditions or constraints.

In various embodiments, the code generating computer (e.g. compiler) generates and identifies the stable paths as follows. Large basic blocks (BBs) of code can be created, identified, or both. These BBs are regions of code instructions, as stored in memory, that are definitely (e.g. with probability 1) sequentially executed. That is, a BB includes multiple instructions which are to be executed one after the other, and the instructions appear in (e.g. L1 cache) memory contiguously and in the order in which they are to be executed.

Additionally, profile-guided optimization may be employed, in which the execution profile of the program is obtained by running the program with certain inputs and then gathering statistics on the branch-outcomes (e.g. indicative of branches taken/not-taken). This information is used to reorder the BBs, and to adjust the branches directions, such that the most-likely sequence of BBs is laid out sequentially in memory, thus forming the stable paths. This effectively increases the span or size of the most-likely sequentially executed block of instructions, or the size of the stable path(s). The probability that a stable path is in fact stable can be determined for example by running the code multiple times with different inputs. A code portion is considered a stable path when the instructions forming the stable path appear contiguously in memory, and, at least with a given threshold probability, such instructions are executed sequentially in the order they occur in memory. Thus, the program counter can simply be incremented repeatedly to point to each instruction in turn. The stable path can (and typically does) include branch instructions. However each branch instruction is either an unconditional branch instruction with the code being arranged so that the target of the branch instruction is the next instruction occurring in memory, or the branch instruction is a conditional branch instruction with a high likelihood that its condition fails, and thus the branch is not taken, and thus next instruction in memory gets executed after the conditional branch. More generally, the prevalence, size, or a combination of prevalence and size, of the stable paths, can be increased through such profile-guided optimization. The arranging of code to include stable paths can therefore include generating, executing and analyzing candidate versions of the code. The candidate versions of code can be adapted or adjusted, e.g. incrementally, until a satisfactory version is reached.

Therefore, a stable path can be generated and identified when that stable path is stable with at least a given threshold probability (e.g. 80%, 90%, 95%, 99%, or higher or lower). The BPU will be inhibited on every instance of that stable path, accepting that sometimes a branch will nonetheless occur in the stable path, and the benefits of prediction will be foregone in those instances. This is expected to be offset by the savings from inhibiting the BPU in other instances where the stable path is in fact executed in the stable manner (e.g. with instructions sequentially executed in the order they appear in memory). Branches in a stable path which lead away from execution in this stable manner may occur in some instances but not others for example based on inputs to the code, data conditions, etc.

The code generating computer identifies the stable paths using a software/hardware (SW/HW) interface mechanism. This mechanism passes information indicating the stable paths to the hardware which is executing the code. The software portion may be such that the information is included in the code as indicators used to inhibit operation of the branch prediction unit during execution of the stable paths. Thus, for example, the code generating computer includes, in the code, markings to identify the starting point of the stable path as well as the length of the stable path (e.g. as the <len>field of the BP-disable instruction) if required. The length information can be used to re-enable or disinhibit the branch predicting unit at or near the end of executing the stable path.

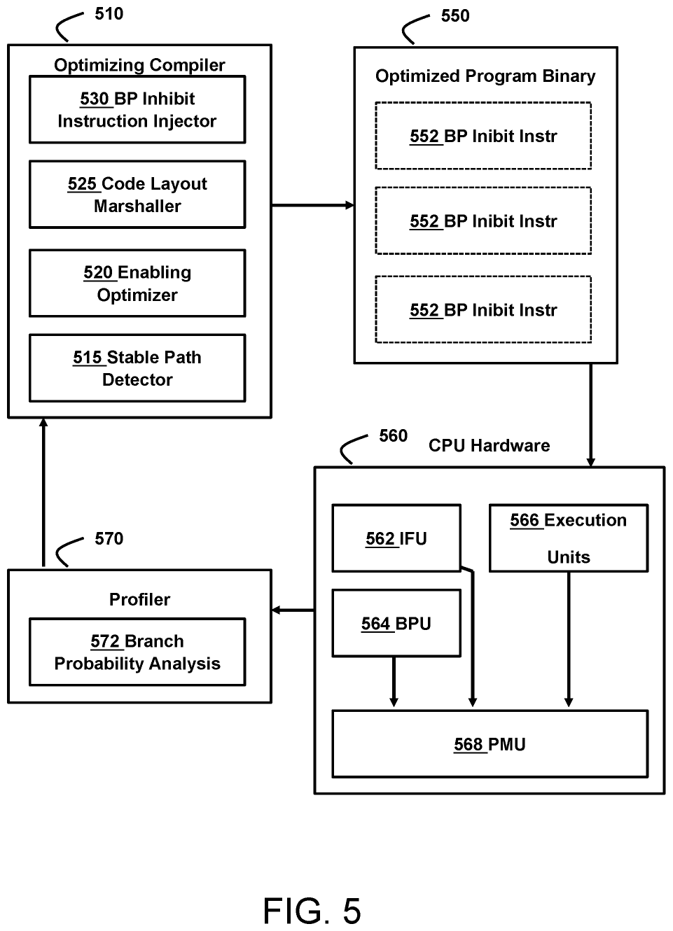

FIG. 5 illustrates an embodiment of the disclosure in which code with stable paths is generated using profile guided optimization. An optimizing compiler 510, which generates the code, is configured to produce an optimized executable computer program code binary in which adequate or maximal stable paths are present. According to the code, the stable paths are each laid out in memory in a respective contiguous region with sequentially executed instructions being sequential in the memory. The stable paths can be guaranteed stable with at least a predetermined or indicated threshold probability. These stable path regions are instrumented with instructions to temporarily inhibit (e.g. disable) branch prediction as already described above. The input to the optimizing compiler can be existing code binary or shared objects, or the program Intermediate Representation (IR) which consists of a richer set of information about the original program structure.

The optimizing compiler 510 includes the following subcomponents (also known as passes): a Stable Path Detector 515, an Enabling Optimizer 520, a Code Layout Marshaller 525 and a BP Inhibit Instruction Injector 530.

The Stable Path Detector 515 operates to detect stable paths in the program code. This may involve augmenting the program Control Flow Graph (CFG) with Branch Probability information to detect intra-function stable path candidates. A code portion may be declared a stable path if it is stable with at least a threshold probability, for example. Probabilities can be estimated based on rules or based on information from the profiler 570, or a combination thereof. Stable paths may initially be provisionally declared and then confirmed after a number of feedback iterations, in which the profiler 570 provides statistics with increased reliability. The statistics may indicate, for example, that the stable path is stable at least a threshold proportion (e.g. 90%) of the time. The stable path detector may detect stable paths based on information from the profiler, analysis of the code to detect the absence of branch instructions, or the like, or a combination thereof.

The Enabling Optimizer 520 operates to increase prevalence, length, or both prevalence and length of stable paths, for example by reconfiguring, refactoring or reordering code. This may involve multiple compiler passes that transform the target code in order to link the stable path candidates together to form longer paths. Examples of such passes include function inlining, hot-cold code splitting, CFG tail duplication, loop unrolling, and loop fusion.

The Code Layout Marshaller 525 operates as follows. After the identification and formation of the stable paths, the Code Layout Marshaller pass lays out basic blocks of the stable paths in memory in order and in contiguous regions. Also, this pass may facilitate that the tail branch conditions for each basic block is expressed and evaluated in such a way that the “not-taken” path is always the most likely outcome.

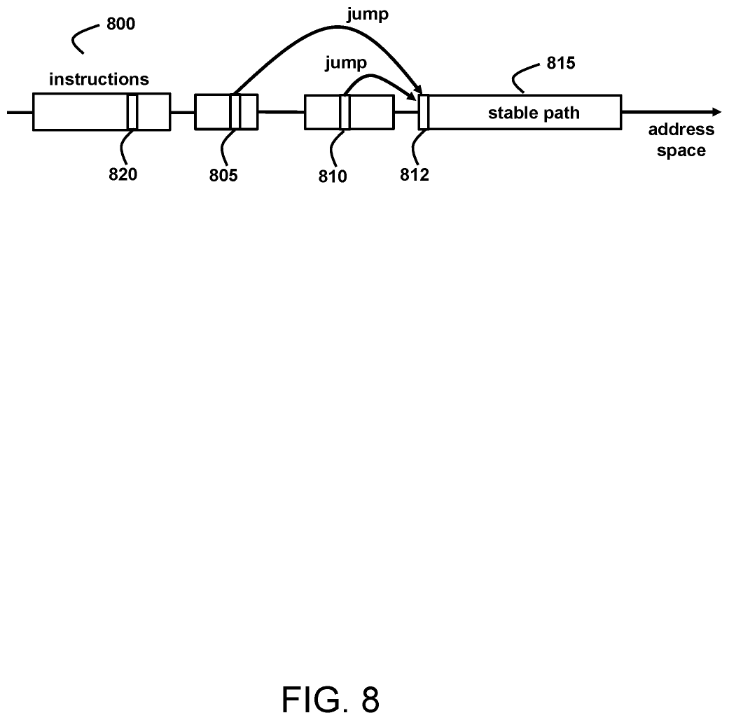

The BP Disable Instruction Injector 530 instruments the program with above-described indicators, e.g. located prior to or at the execution of the stable paths, which are used to inhibit branch prediction. The indicator may be, for example, a specialized branch instruction which leads to the stable path (see e.g. 812 in FIG. 8). For example, branch instructions 810, 815 of FIG. 8 may act as such indicators. The indicator may be a marker instruction (see e.g. 820 in FIG. 8). The indicator may be an instruction included in the computer program code along with but separate from a branch instruction which leads to the stable path. The indicator may be an instruction which precedes the stable path by a fixed number of instructions and which indicates a start of the stable path.

The optimizing compiler 510 generates an instance of an optimized program binary 550, which is a candidate version of the generated computer program code. Notably, the optimized program binary 550 includes one or more BP inhibit (e.g. BP-disable) instructions 552 (indicators used for inhibiting branch prediction) as described above. For profile-guided optimization, this candidate version is tested and potentially further adjusted.

In more detail, the optimized program binary 550 is provided to CPU hardware 560 (hardware component) which is used as a test bed for executing the binary 550 for profiling and further optimization. By way of example, the CPU hardware 560 includes an instruction fetch unit (IFU) 562 which includes or is operatively coupled to a branch prediction unit (BPU) 564. The CPU hardware 560 further includes one or more execution units 566 which execute the instructions as fetched. The execution units 566, upon receiving and executing the BP inhibit instructions 552, will temporarily inhibit operation of the BPU 564 in accordance with such instructions. When the BPU 564 is inhibited (e.g. disabled), the IFU 562 will fetch instructions in a default manner, for example by fetching the next instruction(s) stored sequentially in memory, in a manner which avoids emptying of the instruction pipeline(s) provided to the execution units 566. Therefore the IFU and BPU mechanisms and new CPU instructions (e.g. BP disable instructions 552) support temporary inhibiting or disabling of branch prediction by the BPU, for example by powering down the BPU.

In some embodiments, the CPU hardware 560 further includes a performance monitoring unit (PMU) 568. The PMU 568 provides support for collecting statistics on the directions and targets of the executed branches of the optimized program binary 550. Such mechanisms may be similar to Intel's Last Branch Record (LBR) mechanism, or ARM's Branch Record Buffer Extension (BRBE). The PMU may determine information such as the number or frequency of stable path executions, the lengths of stable paths, whether or not a stable path is in fact executed in the stable manner, and associated information.

The PMU 568 (or another component of the CPU hardware 560) sends branch execution samples or other relevant information to a profiler component 570. The profiler component 570 operates to collect the execution samples for the branch instructions of a target program (i.e. the optimized program binary 550) and to parse and summarize the samples into aggregate statistics on frequency of execution, and the likely direction and target of each branch. Such statistics are then passed to the optimizing compiler 510. The optimizing compiler 510 may use this information to generate a next candidate of the optimized program binary 550 in a next iteration, or to declare the current candidate to be sufficiently optimized for use as an output of the process. The profiler component 570 may perform branch probability analysis 572 to determine, based on frequency observations, the probability of a branch in the code being taken (e.g. in a manner that breaks the stable path by causing execution of an instruction other than the sequentially next instruction in memory). Such information may be used to inform code layout marshalling, BP disable instruction injection, or both. More generally, the profiler component 570 can operate to observe certain outputs of the CPU hardware 560, indicating for example statistics which can be used in code layout marshalling, or indicating statistics on the effectiveness of BPU disabling, or both. The statistics can include branch execution frequency and probabilities of branches occurring, e.g. within the indicated stable paths, in a manner which breaks the stable path. The profiler component 570 provides feedback to the optimizing compiler 510, and the optimizing compiler can adjust the code based on such feedback (e.g. statistics).

Accordingly, arranging the code may include generating, executing and analyzing candidate versions of the executable program code. The arranging may further include adjusting the candidate versions of the program code to arrive at the generated executable program code based on the analyzing. The analyzing may include analyzing determining an indication of probability that the plurality of instructions will be executed in sequence (e.g. by the profiler component).

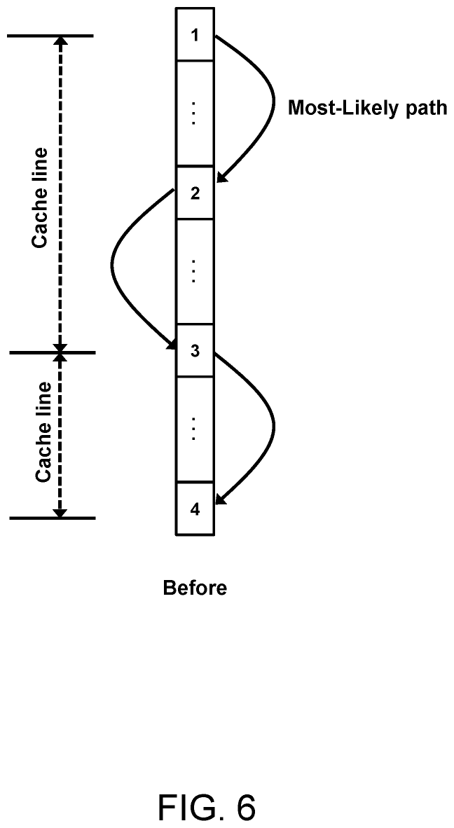

FIG. 6 illustrates an example of code for forming a most likely stable path prior to code layout marshalling, according to an embodiment. Code for forming a stable path are detected (e.g. by stable path detector 515) which includes basic blocks 1, 2, 3, 4 executed in order, with high probability. However, these basic blocks are not stored contiguously in memory. Furthermore, there are cache line alignment issues. In particular, this piece of code spans 4 cache-lines; two are shown in the figure; another one covers the beginning of basic-block number 1, and yet another one covers the ending of basic-block number 4.

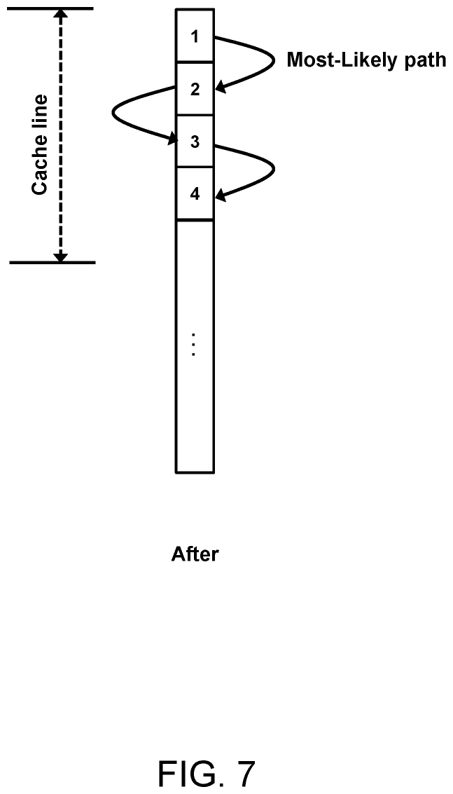

FIG. 7 illustrates the result of code layout marshalling (e.g. by code layout marshaller 525) on the basic blocks 1, 2, 3, 4 of FIG. 6, according to an embodiment. The basic blocks are reordered in memory (in the compiled code) to form a stable path which includes the basic blocks 1, 2, 3, 4 stored contiguously in memory. In addition, an instruction is included along with the stable path which results in BPU inhibition upon at least one execution of the stable path.

FIG. 8 illustrates an example of computer code instructions 800 laid out in address space, in order to illustrate various embodiments of the disclosure. Moving from left to right indicates instructions laid out sequentially in memory. The instructions include branches 805, 810 which lead to a stable path 815, having a beginning point 812. The branch instructions cause the program counter to jump to the value corresponding to the beginning point 812 of the stable path. The stable path itself is stable with high probability, so instructions are expected to be executed sequentially (contiguously) from left to right in the address space with at least this probability. Also illustrated is a dedicated instruction 820 related to BPU inhibition, which may be present in some embodiments and absent in others.

Referring to FIG. 8, in some embodiments, the mechanism for inhibiting the branch prediction unit can be engaged at a point of control, being either branch instruction 805 or 810 which is a branch leading to the stable path 815. The indication of the stable path is associated with these branch instructions 805, 810. In other embodiments, the mechanism for inhibiting the branch prediction unit can be engaged at a point of control, being the beginning point 812 of the stable path 815. Thus, the indication of the stable path may be associated with either branch instructions or the beginning of the stable path. In this way, the computing hardware can be made to identify stable paths during program execution. In this case, the branch instructions 805, 810 and the beginning point instruction 812 may correspond to the instruction that triggers the computer hardware to inhibit branch prediction, when these instructions are fetched.

Also referring to FIG. 8, in some embodiments, the information in the computer code which initiates inhibiting of the branch prediction unit can be associated with the branch instruction 805 or 810 leading to the stable path 815. Thus, the information indicative of BPU inhibition can be delivered via the branch instruction itself. In other embodiments, the information in the computer code which initiates inhibiting of the branch prediction unit can be associated with a dedicated instruction 820 which may occur prior to the stable path 815 and possibly prior to the branch instructions. The dedicated instruction 820 may reference the points of control previously defined, for example the branch instructions 805 or 810, or the beginning point 812 of the stable path. Thus, the information indicative of BPU inhibition can be delivered via a dedicated instruction separate from the referenced branch instruction(s). In this way, the software code can be used to inform the computer hardware of where the stable path occurs in the address space, or where a branch leading to the stable path occurs in the address space. In this case, the dedicated instruction 820 and the branch instructions 805, 810 correspond to the mechanism employed to designate the instruction that triggers the computer hardware to inhibit branch prediction, and to pass that information from software to hardware. The instruction 820 may precede the stable path 815 by a fixed (e.g. variable but specified) number of instructions and may indicate the beginning point 812.

Embodiments of the present disclosure provide for computing apparatus, associated methods, and computer-readable media storing computer program code instructions for operating such apparatus and methods. Yet other embodiments provide for a computer-readable medium storing code having the stable path and indicators for BPU inhibition, as described above. The code includes a stable path (such as stable path 815) which consists essentially of a plurality of instructions to be most probably executed in a sequence. That is, the stable path is stable with at least a predetermined threshold probability. The threshold can depend on the application but might be 80%, 90%, 95%, or 99% for example. The plurality of instructions occur in the stable path contiguously according to the sequence, so that the instructions can be fetched in sequence by incrementing the program counter. The stable path can be generated by a compiler as already described above. The code also includes an indicator which corresponds to the stable path approaching execution. The indicator is included in the computer program code during generation thereof. Suitable indicators might be or might be associated with the branch instructions 805, 810, or the beginning point 812, or the dedicated instruction 820. As already described above, in response to the indicator being read by a computer apparatus executing the computer program code, the apparatus inhibits operation of the branch prediction unit during at least one subsequent execution of the stable path.

In some embodiments, the code executing computer monitors the success/failure of the BP inhibition scheme by tracking at the commit-stage whether the actually executed path did follow the sequential execution of the stable-path (i.e. success) or deviated from it (i.e. failure). Such deviation may occur due to, for example, changes in the input data values that affect the Taken/Not-taken outcomes of the branches in the stable path (e.g. so that the stable path might be broken due to the branch instruction or unbroken). The code-executing computer may then, at some point for some stable paths, determine to not honor the indicators to inhibit BP operation (software hints) anymore, temporarily or permanently. This may occur if the running profile is often deviating from what the code generating computer had observed and had hinted on. In other words, the code-executing computer can override or disregard one or more of the indicators to inhibit operation of the branch prediction unit, as provided in the executable program code. This may be done on a temporary or permanent basis, for example in response to monitored metrics indicating that the benefit of following the indicators is not satisfactory, e.g. being below a threshold.

According to embodiments of the present disclosure, stable paths are identified during code creation (e.g. by a compiler), instead of online by the hardware executing the code. The stable paths are associated with instructions to inhibit branch prediction, which are also included in the code. This alleviates the hardware which is executing the already-compiled code from having to perform certain operations, e.g. in order to detect stable paths. Therefore power burdens on this hardware may be alleviated. This can provide for a more energy-efficient and cost-effective approach than existing solutions.

According to embodiments, the BBs of a not-contiguously-laid-out stable-path are marshaled into a contiguously-laid-out stable-path during code generation, making the code more suitable for BP inhibition or making BP inhibition more advantageous. Thus, the code is adapted for use with BP inhibition mechanisms as described herein. This is in contrast to existing solutions in which code is not changed, but rather BP disabling is based on the existence of single BBs.

According to embodiments, because the marker instructions or prefixes are inserted during code generation, at least some embodiments do not need to rely on short-term repeats of the stable path. More cases of stable paths can be covered even when the repeat-cycle is very long. This is because the BP inhibit indicators are included in the code rather than needing to be tracked by the executing hardware.

According to embodiments, longer stable paths can be identified by the compiler than would be reasonably accommodated by an online solution in which the executing hardware was responsible for identifying stable paths. More energy saving is potentially achievable by inhibiting BP for a larger number of instruction-fetches.

According to embodiments, longer stable paths can be deliberately created during code generation (e.g. by unrolling, inlining, partial-inlining, etc.) by the compiler if deemed beneficial. This may create more opportunity for power savings.

According to embodiments, the BP-inhibition mechanism gates the circuit-activity in the BP, and thus facilitates dynamic power savings. In other embodiments, the storage elements of the BPU may be placed in a drowsy mode during BP inhibition. In the drowsy mode, supply voltage may be lowered to save power even though the state of the memory elements is kept. This approach may save on the leakage power in addition to dynamic power. This approach may involve taking into account wake-up times when deciding to turn the circuit back to fully-operational mode from drowsy mode. Thus, circuitry may continue to operate in drowsy mode even after BP inhibition is ceased. When the circuitry is in drowsy mode, its response time increases, and thus it may not suit all components of the BP, or may need additional changes to tolerate the added delay.

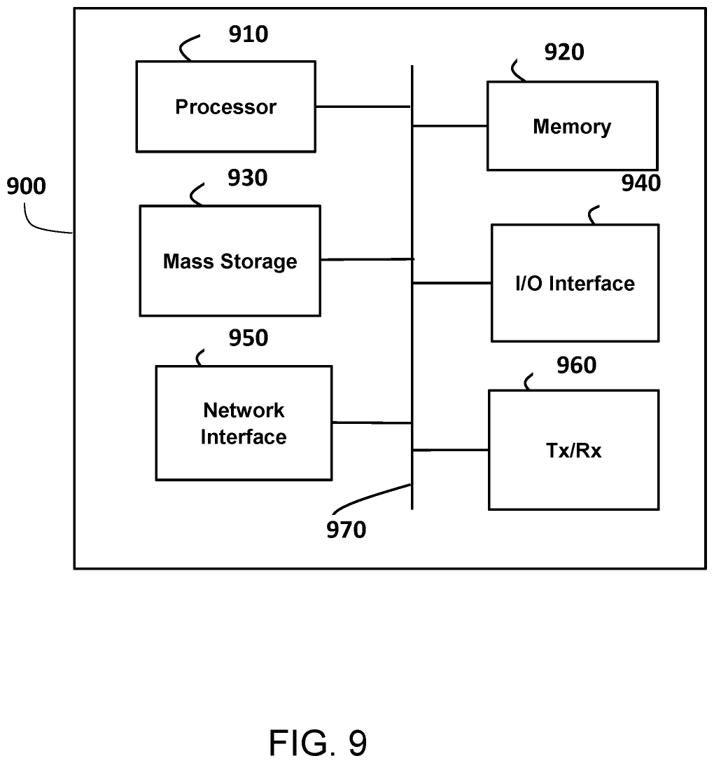

FIG. 9 illustrates an apparatus 900 that may perform any or all of operations of the above methods and features explicitly or implicitly described herein, according to different aspects of the present disclosure. For example, a computer may be configured as the apparatus 900. In some aspect, apparatus 900 can be a device that connects to the network infrastructure over a radio interface, such as a mobile phone, smart phone or other such device that may be classified as user equipment (UE). In some aspects, the apparatus 900 may be a computer such as a general purpose or special purpose computer, e.g. installed in an electronic device, vehicle, etc. In some aspects, the apparatus 900 may be a Machine Type Communications (MTC) device (also referred to as a machine-to-machine (m2m) device), or another such device that may be categorized as a UE despite not providing a direct service to a user. In some aspects, apparatus 900 may be used to implement one or more aspects described herein. In some embodiments, the apparatus 900 may be a user equipment (UE), an AP, a STA, an initiator, a transmitter, a receiver, a responder or the like as appreciated by a person skilled in the art.

As shown, the apparatus 900 may include a processor 910, such as a Central Processing Unit (CPU) or specialized processors such as a Graphics Processing Unit (GPU) or other such processor unit, memory 920, non-transitory mass storage 930, input-output interface 940, network interface 950, and a transceiver 960, all of which are communicatively coupled via bi-directional bus 970. Transceiver 960 may include one or multiple antennas According to certain aspects, any or all of the depicted elements may be utilized, or only a subset of the elements. Further, apparatus 900 may contain multiple instances of certain elements, such as multiple processors, memories, or transceivers. Also, elements of the hardware device may be directly coupled to other elements without the bi-directional bus. Additionally, or alternatively to a processor and memory, other electronics or processing electronics, such as integrated circuits, application specific integrated circuits, field programmable gate arrays, digital circuitry, analog circuitry, chips, dies, multichip modules, substrates or the like, or a combination thereof may be employed for performing the required logical operations.

The memory 920 may include any type of non-transitory memory such as static random-access memory (SRAM), dynamic random-access memory (DRAM), synchronous DRAM (SDRAM), read-only memory (ROM), any combination of such, or the like. The mass storage element 930 may include any type of non-transitory storage device, such as a solid-state drive, hard disk drive, a magnetic disk drive, an optical disk drive, USB drive, or any computer program product configured to store data and machine executable program code. According to certain aspects, the memory 920 or mass storage 930 may have recorded thereon statements and instructions executable by the processor 910 for performing any method operations described herein.

Aspects of the present disclosure can be implemented using electronics hardware, software, or a combination thereof. In some aspects, this may be implemented by one or multiple computer processors executing program instructions stored in memory. In some aspects, the invention is implemented partially or fully in hardware, for example using one or more field programmable gate arrays (FPGAs) or application specific integrated circuits (ASICs) to rapidly perform processing operations.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A computer apparatus comprising a processor operatively coupled to memory, the apparatus configured to:
generate executable computer program code having a stable path which consists essentially of a plurality of instructions to be most probably executed in a sequence, the plurality of instructions occurring in the stable path contiguously according to the sequence;
the generating of the executable computer program code comprising arranging the computer program code to maximize a length of the stable path while respecting one or more conditions or constraints,
the generating of the executable computer program code comprising including an indicator therein to inhibit operation of a branch prediction unit during execution of the stable path; and
store the generated executable computer program code for subsequent use.

2. The apparatus of claim 1, wherein the one or more constraints or conditions include maintaining at least a threshold probability that the plurality of instructions will be executed in sequence.

3. The apparatus of claim 1, wherein the indicator is a specialized branch instruction which leads to the stable path, a marker instruction, an instruction included in the computer program code along with but separate from a branch instruction which leads to the stable path, or an instruction which precedes the stable path by a fixed number of instructions and which indicates a start of the stable path.

4. The apparatus of claim 1, wherein the arranging comprises generating, executing and analyzing candidate versions of the executable program code, and adjusting the candidate versions of the program code to arrive at the generated executable program code based on the analyzing.

5. The apparatus of claim 4, wherein the analyzing comprises determining an indication of probability that the plurality of instructions will be executed in sequence.

6. A computer apparatus comprising a processor operatively coupled to memory and a branch prediction unit, the apparatus configured to:
execute computer program code stored in memory and having a stable path which consists essentially of a plurality of instructions to be most probably executed in a sequence, the plurality of instructions occurring in the stable path contiguously according to the sequence;
read, in the computer program code, an indicator corresponding to the stable path approaching execution, the indicator included in the computer program code during generation thereof; and
in response to reading the indicator, inhibit operation of the branch prediction unit during at least one subsequent execution of the stable path.

7. The apparatus of claim 6, wherein the indicator is that the stable path is about to be executed or is predicted to be executed.

8. The apparatus of claim 6, wherein the indicator is associated with a branch instruction leading to the stable path.

9. The apparatus of claim 6, wherein the indicator is associated with a start of the stable path.

10. The apparatus of claim 6, wherein inhibiting operation of the branch prediction unit comprises storing data in a data structure which is also used for support operation of the branch prediction unit, the stored data used in triggering said inhibiting operation of the branch prediction unit during at least one subsequent execution of the stable path.

11. The apparatus of claim 6, wherein inhibiting operation of the branch prediction unit comprises storing data in a data structure which is dedicated for use in triggering said inhibiting operation of the branch prediction unit during at least one subsequent execution of the stable path.

12. The apparatus of claim 6, wherein the indicator is included in the computer program code as a specialized branch instruction which leads to the stable path.

13. The apparatus of claim 6, wherein the indicator is included in the computer program code along with but separate from a branch instruction which leads to the stable path.

14. The apparatus of claim 6, wherein the indicator is included in the computer program code as an instruction which precedes the stable path by a fixed number of instructions and which indicates a start of the stable path.

15. The apparatus of claim 6, wherein the indicator indicates a length of the stable path and the apparatus is configured to cease inhibiting operation of the branch prediction unit following execution of the stable path.

16. A non-transitory computer readable medium having stored thereon computer program code comprising:
a stable path which consists essentially of a plurality of instructions to be most probably executed in a sequence, the plurality of instructions occurring in the stable path contiguously according to the sequence;
an indicator in the computer program code and corresponding to the stable path approaching execution, the indicator included in the computer program code during generation thereof;
wherein in response to the indicator being read by a computer apparatus executing the computer program code, the apparatus inhibits operation of the branch prediction unit during at least one subsequent execution of the stable path.

17. A method comprising, by a computer:
generating executable computer program code having a stable path which consists essentially of a plurality of instructions to be most probably executed in a sequence, the plurality of instructions occurring in the stable path contiguously according to the sequence;
the generating of the executable computer program code comprising arranging the computer program code to maximize a length of the stable path while respecting one or more conditions or constraints,
the generating of the executable computer program code comprising including an indicator therein to inhibit operation of a branch prediction unit during execution of the stable path; and
storing the generated executable computer program code for subsequent use.

18. A method comprising, by a computer having a branch prediction unit:
executing computer program code stored in memory and having a stable path which consists essentially of a plurality of instructions to be most probably executed in a sequence, the plurality of instructions occurring in the stable path contiguously according to the sequence;
reading, in the computer program code, an indicator corresponding to the stable path approaching execution, the indicator included in the computer program code during generation thereof; and
in response to reading the indicator, inhibiting operation of the branch prediction unit during at least one subsequent execution of the stable path.
